(19) United States
(12) Patent Application Publication
(10) Pub. No.: US 2007/0251621 A1
(43) Pub. Date: Nov. 1, 2007

(54) Vehicle Tire, Method for Estimating Adherence Properties of a Vehicle Tire and a Vehicle Drive Assisting Method

(76) Inventor: Pascal Prost, Riom (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/664,249

(22) PCT Filed: Sep. 27, 2005
(86) PCT No.: PCT/EP05/54848

§ 371 Date: Mar. 29, 2007

(30) Foreign Application Priority Data
Sep. 29, 2004 (FR) 0410325

(51) Int. Cl. B60C 11/24

(52) U.S. Cl. 152/154.2; 152/209.1; 701/31; 701/36

(57) ABSTRACT

A tire comprising at least one carcass-type reinforcement structure, formed of reinforcement elements, which is anchored on either side of the tire to a bead the base of which is intended to be mounted on a rim seat, each bead being extended radially towards the outside by a sidewall, the sidewalls joining radially towards the outside a tread, the beads, the sidewalls and the tread being formed in part of rubber compounds. The tire comprises at least one device for measuring the internal temperature of a rubber compound of the tread and said device is fastened within the rubber compound of the tread.

The present invention relates to a tire intended to be fitted on a vehicle, and more particularly intended to be fitted on a two-wheeled vehicle such as a motorcycle. The invention also relates to a method of estimating the grip properties of a tire and a driving assistance method for such a vehicle.

Although not limited to such an application, the invention will be more particularly described with reference to such a motorcycle tire.

The reinforcement armature or reinforcement of tires and in particular of motorcycle tires is currently—and most frequently—formed by stacking one or more plies conventionally referred to as “carcass plies”, “crown plies”, etc. This manner of designating the reinforcement armatures is derived from the manufacturing process, which consists of producing a series of semi-finished products in the form of plies, provided with cord reinforcing threads which are frequently longitudinal, which plies are then assembled or stacked in order to build a tire blank. The plies are produced flat, with large dimensions, and are subsequently cut according to the dimensions of a given product. The plies are also assembled, in a first phase, substantially flat. The blank thus produced is then shaped to adopt the toroidal profile typical of tires. The semi-finished products referred to as “finishing” products are then applied to the blank, to obtain a product ready to be vulcanized.

Such a “conventional” type of process involves, in particular, for the phase of manufacture of the blank of the tire, the use of an anchoring element (generally a bead wire), used for anchoring or holding the carcass reinforcement in the zone of the beads of the tire. Thus, in this type of process, a portion of all the plies constituting the carcass reinforcement (or of only a part thereof) is turned up around a bead wire arranged in the bead of the tire. In this manner, the carcass reinforcement is anchored in the bead.

The general adoption of this type of conventional process in the industry, despite the numerous different ways of producing the plies and assemblies, has led the person skilled in the art to use a vocabulary which reflects the process; hence the generally accepted terminology, comprising in particular the terms “plies”, “carcass”, “bead wire”, “shaping”, to designate the change from a flat profile to a toroidal profile, etc.

There are nowadays tires which do not, properly speaking, comprise “plies” or “bead wires” in accordance with the preceding definitions. For example, document EP 0 582 196 describes tires manufactured without the aid of semi-finished products in the form of plies. For example, the reinforcement elements of the different reinforcement structures are applied directly to the adjacent layers of rubber mixes, the whole being applied in successive layers to a toroidal core the form of which makes it possible to obtain directly a profile similar to the final profile of the tire being manufactured. Thus, in this case, there are no longer any “semi-finished products”, nor “plies”, nor “bead wires”. The base products, such as the rubber mixes and the reinforcement elements in the form of cords or filaments, are applied directly to the core. As this core is of toroidal form, the blank no longer needs to be shaped in order to change from a flat profile to a profile in the form of a torus.

Furthermore, the tires described in this document do not have the “conventional” upturn of the carcass ply around a bead wire. This type of anchoring is replaced by an arrangement in which circumferential cords are arranged adjacent to said sidewall reinforcement structure, the whole being embedded in an anchoring or bonding rubber mix.

There are also processes for assembly on a toroidal core using semi-finished products specially adapted for quick, effective and simple laying on a central core. Finally, it is also possible to use a mixture comprising at the same time certain semi-finished products to produce certain architectural aspects (such as plies, bead wires, etc.), whereas others are produced from the direct application of mixes and/or reinforcement elements.

In the present document, in order to take into account recent technological developments both in the field of manufacture and in the design of products, the conventional terms such as “plies”, “bead wires” etc. are advantageously replaced by neutral terms or terms which are independent of the type of process used. Thus, the term “carcass-type reinforcing thread” or “sidewall reinforcing thread” is valid as a designation for the reinforcement elements of a carcass ply in the conventional process, and the corresponding reinforcement elements, generally applied at the level of the sidewalls, of a tire produced in accordance with a process without semi-finished products. The term “anchoring zone”, for its part, may equally well designate the “traditional” upturn of a carcass ply around a bead wire of a conventional process and the assembly formed by the circumferential reinforcement elements, the rubber mix and the adjacent sidewall reinforcement portions of a bottom zone produced with a process using application on a toroidal core.

The longitudinal direction of the tire, or circumferential direction, is the direction corresponding to the periphery of the tire and defined by the direction of travel of the tire.

A circumferential plane or circumferential section plane is a plane perpendicular to the axis of rotation of the tire. The equatorial plane is the circumferential plane passing through the centre or crown of the tread.

The transverse or axial direction of the tire is parallel to the axis of rotation of the tire.

A radial plane contains the axis of rotation of the tire.

As in the case of all other tires, radialization of motorcycle tires is taking place, the architecture of such tires comprising a carcass reinforcement formed of one or two layers of reinforcement elements forming with the circumferential direction an angle which may be between 65° and 90°, said carcass reinforcement being radially surmounted by a crown reinforcement formed at least of generally textile reinforcement elements. There are however non-radial tires to which the invention also relates. The invention also relates to partially radial tires, that is to say the reinforcement elements of the carcass reinforcement of which are radial over at least part of said carcass reinforcement, for example in the part corresponding to the crown of the tire.

Numerous crown reinforcement architectures have been proposed, depending on whether the tire will be intended for mounting at the front of the motorcycle or at the rear. A first structure consists, for said crown reinforcement, of using solely circumferential cables, and said structure is more particularly used for the rear position. A second structure, directly inspired by the structures commonly used for tires for passenger cars, has been used to improve the wear resistance, and consists in using at least two working crown layers of reinforcement elements which are parallel to each other within each layer but are crossed from one layer to the next, forming acute angles with the circumferential direction, such tires being more particularly suited for the front of motorcycles. Said two working crown layers may be associated with at least one layer of circumferential elements, which are generally obtained by helical winding of a strip of at least one reinforcement element coated with rubber.

The choice of the crown architectures of the tires directly affects certain properties of the tires such as wear, endurance, grip or alternatively also ride comfort or, in the case in particular of motorcycles, stability. However, other parameters of the tires such as the nature of the rubber mixes constituting the tread also affect the properties of said tire. The selection and the nature of the rubber mixes constituting the tread are for example essential parameters relating to the wear properties. The selection and the nature of the rubber mixes constituting the tread also affect the grip properties of the tire.

Furthermore, it is also known to the person skilled in the art that the physical-chemical properties of rubber mixes vary according to the temperature, and therefore that the temperature has an effect on the properties of the tread of a tire.

The object of the invention is to provide a tire making it possible to optimize the operation of the vehicle and more precisely to optimize the use of the vehicle according to the grip properties of the tread of said tire.

This aim was achieved according to the invention by a tire comprising at least one carcass-type reinforcement structure, formed of reinforcement elements, which is anchored on either side of the tire to a bead the base of which is intended to be mounted on a rim seat, each bead being extended radially towards the outside by a sidewall, the sidewalls joining radially towards the outside a tread, the beads, the sidewalls and the tread being formed in part of rubber compounds, said tire comprising at least one device for measuring the internal temperature of a rubber compound of the tread, said device being a system fixed within the rubber compound of the tread.

The tire thus proposed according to the invention incorporates a device for measuring the temperature of the rubber compound of the tread which will make it possible to obtain information on the properties of the tire such as in particular its ability to be deformed, which has a direct influence on the grip of the tire. This information made available to the driver can enable him to modify his driving behavior and the use which he makes of the vehicle, or more exactly of the tires. The positioning within the rubber compound enables the measuring device to give very precisely the value of the temperature of the rubber mix on which the properties of the material depend.

According to a first variant embodiment of the invention, the system emits a signal which conveys the temperature of the point of fastening of said system. Such an embodiment is particularly advantageous since it makes it possible to transmit the information on the temperature without requiring a wired connection.

According to this first variant embodiment, the temperature measurement system is for example a wireless temperature sensor, which can for example be queried by radio waves. Such a system is advantageously associated with a radio antenna within the rubber compound and a radio antenna on the vehicle to create a radio link between an interrogator and the sensor. Such a system is furthermore advantageously capable of functioning without being associated with an energy source, such as a battery, present within the rubber compound, said energy source possibly being associated with the interrogator placed on the vehicle.

According to a second variant embodiment of the invention, the system is connected to a rotary hub for transmitting a signal which conveys the temperature of the point of fastening of said system. Such a connection may make it possible for the sensor to be supplied with power and the signal to be transmitted by the rotary hub to a device for processing said signal which is positioned on the vehicle.

The tire according to the invention is, as mentioned previously, more particularly advantageous when fitted on a motorcycle, the balance, stability and therefore driving of such a vehicle being directly dependent on the grip of the tires. In the same manner, a reduction in the grip of a tire on a motorcycle is basic information for the rider.

Motorcycle tires are produced with an amount of curvature which is most frequently greater than 0.2 in order to be used in a leaning attitude. It therefore turns out that, depending on the use of the motorcycle, either in a straight line or on a curve, the part of the tread in contact with the ground is not the same.

One advantageous embodiment of the invention thus provides for the tire to comprise at least three devices for measuring the internal temperature of the rubber compound of the tread.

According to this advantageous embodiment of the invention and when the temperature measuring devices are distributed in the axial direction of the tire, it is thus possible to know the temperature of the rubber compound of the tread in contact with the ground.

So as to facilitate the putting in place of the temperature measuring devices, the tire according to the invention is advantageously produced by a manufacturing technique of the “hard core” or “rigid mould” type as mentioned previously.

Such a tire which, as mentioned previously, is advantageously produced using a technique of the hard or toroidal core type makes it possible in particular to put in place temperature measuring devices in a virtually final position, a shaping step not being required for this type of process, it furthermore being possible to identify said final position perfectly. This is because manufacture of hard core type may make it possible to insert a temperature measuring device in accordance with predetermined indexing.

The carcass-type reinforcement structure advantageously comprises reinforcement elements forming an angle of between 65° and 90° with the circumferential direction.

Between the carcass-type reinforcement structure and the tread, the tire also comprises a crown reinforcement architecture.

Conventional crown reinforcement architectures for motorcycle tires vary according to whether the tire will be intended for mounting at the front of the motorcycle or at the rear. A first structure consists, for said crown reinforcement, of using solely circumferential cables, and said structure is more particularly used for the rear position. A second structure, directly inspired by the structures commonly used for tires for passenger cars, has been used to improve the wear resistance, and consists in using at least two crown layers of reinforcement elements which are parallel to each other within each layer but are crossed from one layer to the next, forming acute angles with the circumferential direction, such tires being more particularly suited for the front of motorcycles. Said two crown layers may be surmounted radially by at least one layer of circumferential elements.

According to a preferred embodiment of the invention, the crown reinforcement structure of the tire comprises at least two layers of reinforcement elements such that from one layer to the next the reinforcement elements form angles of between 20 and 160°, and preferably between 40 and 100°, between them.

According to a preferred embodiment of the invention, the reinforcement elements of the working layers are made of textile material.

Preferably also, the reinforcement elements of a layer of circumferential reinforcement elements are metallic and/or made of textile and/or made of glass. The invention provides in particular for the use of reinforcement elements of different natures in one and the same layer of circumferential reinforcement elements.

More preferably still, the reinforcement elements of the layer of circumferential reinforcement elements have an elasticity modulus greater than 6000 N/mm².

The invention also proposes a method of estimating the grip properties of a tire, consisting of measuring the internal temperature of the tread with at least one temperature measuring device fastened within the rubber compound of the tread of said tire.

The measurement of the internal temperature of the tread effectively results only in an estimation of the grip, other characteristics such as in particular the temperature of the surface of the tread being necessary to determine more precisely the grip of the tire.

According to a first variant embodiment of the invention, the grip properties are estimated before the vehicle begins traveling.

According to a second variant embodiment of the invention, the grip properties are estimated while the vehicle is traveling.

The invention also proposes the use of at least one temperature measuring device fastened within the rubber compound of the tread of a tire in order to estimate the grip properties of said tire.

According to a first variant embodiment of the invention, the temperature measuring device is used before the vehicle begins traveling.

According to a second variant embodiment of the invention, the temperature measuring device is used while the vehicle is traveling.

The invention also proposes a driving assistance method for a vehicle, in particular for driving a motorcycle, according to which the tires incorporate at least one device fixed within the rubber compound of the tread which measures the internal temperature of said rubber compound of the tread, a signal which conveys the temperature of the point of fastening of said system is transmitted to an implementing device and the implementing device informs the driver and/or regulates the power, the torque and/or the speed of the vehicle.

Such a process according to the invention makes it possible at any time to provide information possibly transmitted to the driver and to permit a type of driving or on the contrary to correct the driving of the vehicle in order to adapt it to the grip characteristics of the treads or at the very least part of the parts of the treads of the tires in contact with the ground.

According to a first variant embodiment of the invention, the signal which conveys the temperature of the point of fastening of said system is transmitted by a wireless temperature sensor, which can for example be queried by radio waves and is advantageously associated with a radio antenna within the rubber compound and a radio antenna on the vehicle.

According to a second embodiment of the invention, the signal which conveys the temperature of the point of fastening of said system is transmitted by connection via a rotary hub.

One particularly advantageous embodiment of the invention provides for the temperature measurement, the transmission of the signal and the information and/or the regulation to be effected before the vehicle begins traveling. According to this embodiment, the driver of the vehicle may receive this information before traveling and know what use he can make of his vehicle.

Another advantageous embodiment of the invention provides for the temperature measurement, the transmission of the signal and the information and/or the regulation to be effected while the vehicle is traveling. According to this embodiment, the driver of the vehicle may receive this information during travel and know what use he can make of his vehicle.

Variant embodiments of the driving assistance method according to the invention provide for the information relating to the temperature to be transmitted to the implementing device which regulates the driving of the vehicle for example by limiting the power, the torque and/or the speed thereof.

One variant of the invention, in particular for regulating the vehicle during travel, provides for the implementing device to receive an additional measurement of the temperature of the outer surface of the tire and preferably a measurement of the temperature of the contact surface of the tire with the ground. This second temperature measurement provides additional information on the properties of the tread and on the grip thereof.

The invention also proposes the use of at least one temperature measurement system, such as those mentioned previously, within the rubber material constituting the tread of a tire fitted on a vehicle for assisting with the driving of said vehicle, said measurement system being fixed within the rubber compound of the tread.

According to a first variant embodiment of the invention, the temperature measurement system is used before the vehicle begins traveling.

According to a second variant embodiment of the invention, the temperature measurement system is used while the vehicle is traveling.

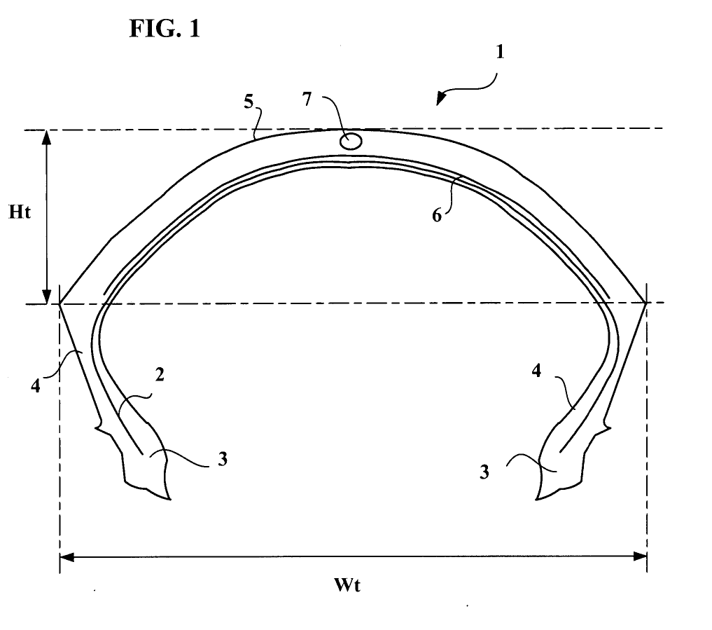

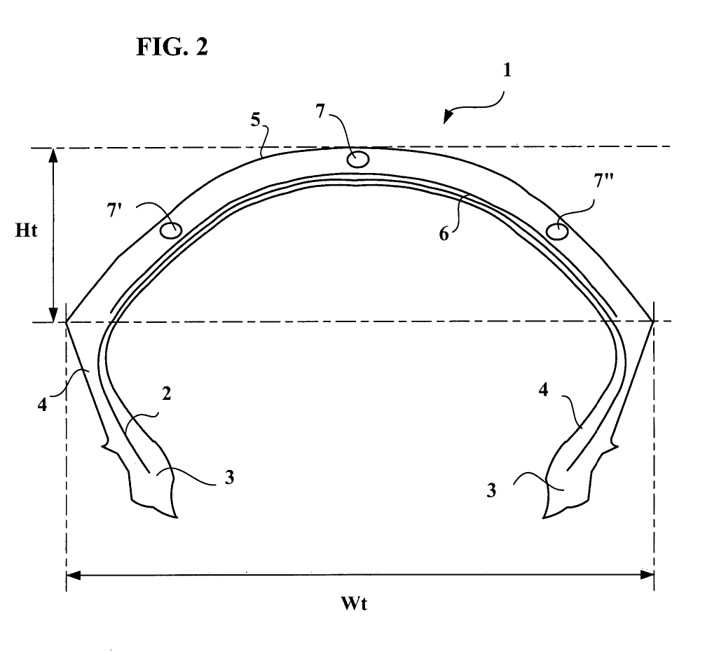

Other advantageous details and characteristics of the invention will become apparent hereafter from the description of the examples of embodiment of the invention with reference to FIGS. 1 and 2, which depict:

FIG. 1: a meridian view of a diagram of a tire according to a first embodiment of the invention,

FIG. 2: a meridian view of a diagram of a tire according to a second embodiment of the invention.

FIGS. 1 and 2 are not shown to scale in order to simplify understanding thereof.

FIG. 1 depicts a tire 1 comprising a carcass reinforcement formed of a single layer 2 comprising reinforcement elements of textile type. The layer 2 is formed of radially arranged reinforcement elements. The radial positioning of the reinforcement elements is defined by the angle of lay of said reinforcement elements; a radial arrangement corresponds to an angle of lay of said elements relative to the longitudinal direction of the tire of between 65° and 90°.

Said carcass layer 2 is anchored on either side of the tire 1 in a bead 3 the base of which is intended to be mounted on a rim seat. Each bead 3 is extended radially towards the outside by a sidewall 4, said sidewall 4 joining the tread 5 radially towards the outside. The tire 1 thus formed has a value of curvature greater than 0.15 and preferably greater than 0.3. The value of curvature is defined by the ratio Ht/Wt, that is to say by the ratio of the height of the tread to the maximum width of the tread of the tire. The value of curvature will be advantageously between 0.25 and 0.5 for a tire intended to be mounted at the front of a motorcycle and will be advantageously between 0.2 and 0.5 for a tire intended to be mounted at the rear.

The tire 1 also comprises a crown reinforcement 6, the details of which are not shown in the figures. As mentioned previously, the crown reinforcement may comprise at least one layer of reinforcement elements which are parallel to each other and form with the circumferential direction acute angles and/or a layer of circumferential reinforcement elements. In the case of the crown reinforcement of a tire comprising at least two layers of reinforcement elements forming acute angles with the circumferential direction, said reinforcement elements are crossed from one layer to the next, forming angles of between 40 and 100° between them.

In accordance with the invention, the tire comprises a device 7 for measuring the internal temperature of the rubber compound of the tread 5. This measuring device 7 is for example a wireless temperature sensor, which can for example be queried by radio waves and is advantageously associated with a radio antenna within the rubber compound and a radio antenna on the vehicle; the details of embodiment are not shown in the drawings. This type of sensor has the advantage of not requiring a power supply; it provides information on the temperature of the rubber compound which surrounds it by modifying a wave which it receives and retransmits.

According to this embodiment, it is therefore not necessary to provide wire conductors to connect the sensor to an implementing device which receives the signal emitted by the sensor.

The implementing device which receives the signal emitted by the sensor analyses it and communicates information to the driver, or alternatively acts directly on the vehicle.

The driver thus benefits from driving assistance which indicates or alternatively imposes on him the limits of use of the vehicle. This information of course becomes a safety tool in particular in the case of driving a motorcycle, where knowledge of the grip potential of the tires may for example prevent a fall during use of the tire in a leaning attitude on bends. The driver can then advantageously adapt his speed, the power and/or the torque used as a function of the temperature of the rubber compound of the tread.

Another advantage of the tires according to the invention may also be to limit their wear by use better matched to their condition at a given moment.

FIG. 1 depicts only a single temperature measuring device 7 within the tread 5. According to other variant embodiments of the invention, a distribution of several temperature measuring devices may be provided within the tread on the periphery thereof.

FIG. 2 illustrates a second embodiment of the invention more particularly suited to the case of a motorcycle. According to this embodiment, the tire comprises at least three devices 7, 7′, 7″ for measuring the internal temperature of the rubber compound of the tread 5 which are distributed over the axial width of the tread 5.

The first temperature measuring device 7 is put in place in the zone of the equatorial plane of the tire 1 and makes it possible to give information on the internal temperature of the part of the tread 5 in contact with the ground when the motorcycle is following a rectilinear path.

The other two temperature measuring devices 7′ and 7″ are put in place in the axially outer parts of the tread 5 of the tire 1 and each give information on the internal temperature of an axially outer part of the tread 5 in contact with the ground when the motorcycle is following a curved path, the tire 1 then being used in a leaning attitude.

As in the case of FIG. 1, variant embodiments of the invention provide for a distribution of several temperature measuring devices within the tread on the periphery thereof.

Whatever the type of embodiment according to the invention, the data relating to the temperature which are measured within the tread by each of the measuring devices are transmitted to an implementing device. This implementing device advantageously comprises a software-type data processing system which will make it possible to define an instruction, taking into account the data originating from each of the tires and in the case of a motorcycle from the front and rear tires. The implementing device thus permanently defines driving assistance instructions at a given interval.

The instruction is then either transmitted to the driver of the vehicle, who will be able to adapt his driving mode, or transmitted directly to a processor which limits the capacity of the vehicle for example in terms of power, torque and/or speed. Such an instruction is notably particularly apt during travel, but may also prove useful before travel in order to ensure that travel begins under the best conditions.

The vehicle fitted with such tires may also comprise, as mentioned previously, temperature sensors for the surface of the tire. These are for example infrared sensors. Provision of this additional data relating to the surface temperature of the tread of the tires supplements the information and may make it possible further to improve the driving of the vehicle.

1. A tire comprising at least one carcass-type reinforcement structure, formed of reinforcement elements, which is anchored on either side of the tire to a bead the base of which is intended to be mounted on a rim seat, each bead being extended radially towards the outside by a sidewall, the sidewalls joining radially towards the outside a tread, the beads, the sidewalls and the tread being formed in part of rubber compounds, wherein the tire comprises at least one device for measuring the internal temperature of a rubber compound of the tread and wherein said device is fixed within the rubber compound of the tread.

2. A tire according to claim 1, wherein the device emits a signal which conveys the temperature of the point of fastening of said system.

3. A tire according to claim 1, wherein the device is a wireless temperature sensor which can for example be queried by radio waves.

4. A tire according to claim 1, wherein the device is connected to a rotary hub for transmitting a signal which conveys the temperature of the point of fastening of said device.

5. A tire according to claim 1, wherein the tire comprises at least three devices for measuring the internal temperature of the rubber compound of the tread.

6. The use of a tire as described according to claim 1, for a two-wheeled motor-driven vehicle such as a motorcycle.

7. A method of estimating the grip properties of a tire, comprising measuring the internal temperature of the tread with at least one temperature measuring device fastened within the rubber compound of the tread of said tire.

8. A method for estimating grip properties of a tire comprising the steps of providing at least one temperature measuring device fastened and fastening the device within the rubber compound of the tread of the tire.

9. A driving assistance method for a vehicle comprising tire/wheel mounted assemblies, wherein the tires incorporate at least one device fixed within the rubber compound of the tread and measuring the internal temperature of said rubber compound of the tread wherein a signal which conveys the temperature of the point of fastening of said device is transmitted to an implementing device and wherein the implementing device informs the driver and/or regulates the power and/or the torque and/or the speed of the vehicle.

10. A driving assistance method for a vehicle according to claim 9, wherein the signal which conveys the temperature of the point of fastening of said system is transmitted by a wireless temperature sensor which can for example be queried by radio waves and is associated with a radio antenna within the rubber compound and a radio antenna on the vehicle.

11. A driving assistance method for a vehicle according to claim 9, wherein the signal which conveys the temperature of the point of fastening of said system is transmitted by connection by means of a rotary hub.

12. A driving assistance method for a vehicle according to claim 9, wherein the temperature measurement, the transmission of the signal and the information and/or regulation are effected before the vehicle begins traveling.

13. A driving assistance method for a vehicle according to claim 9, wherein the temperature measurement, the transmission of the signal and the information and/or regulation are effected while the vehicle is traveling.

14. A driving assistance method for a vehicle according to claim 9, wherein the implementing device receives a measurement of the temperature of the outer surface of the tire and preferably a measurement of the temperature of the contact surface of the tire with the ground.

15. A method for assisting with the driving of a vehicle comprising the steps of providing at least one temperature measurement system, and positioning the system within the rubber material constituting the tread of a tire fitted on the vehicle such that the measurement system is fixed within the rubber compound of the tread.

16. The method according to claim 15, wherein the system is actuated before the vehicle begins traveling.

17. The method according to claim 15, wherein the system is actuated while the vehicle is traveling.

18. The method according to claim 15, wherein the vehicle is a two-wheeled motor-driven vehicle.
